(19) United States
(12) Patent Application Publication
(10) Pub. No.: US 2020/0140588 A1
(43) Pub. Date: May 7, 2020

(54) AQUEOUS COATING MATERIAL, SUBSTRATE WITH COATING FILM AND ITS PRODUCTION METHOD

(71) Applicant: AGC Inc., Chiyoda-ku (JP)

(72) Inventors: Shuhei OCHI, Chiyoda-ku (JP); Shiori Yoshigami, Chiyoda-ku (JP); Shun Saito, Chiyoda-ku (JP)

(73) Assignee: AGC Inc., Chiyoda-ku (JP)

(21) Appl. No.: 16/731,168

(22) Filed: Dec. 31, 2019

Related U.S. Application Data
(63) Continuation of application No. PCT/JP2018/025745, filed on Jul. 6, 2018.

(30) Foreign Application Priority Data
Jul. 7, 2017 (JP) 2017-133707

(51) Int. Cl. C08F 214/24; C09D 127/12; C09D 5/02; C09D 7/61

(52) U.S. Cl. CPC C08F 214/247; C09D 127/12; C08K 2003/2241; C09D 7/61; C09D 5/02

(57) ABSTRACT

To provide an aqueous coating material capable of forming a coating film which is excellent in the weather resistance and has a stable coating film surface, and a substrate with a coating film which is excellent in the weather resistance and which has a stable coating film surface.

An aqueous coating material comprising particles of a fluorinated polymer having units based on a fluoroolefin and units having a hydrophilic group; a specific aminosilane and a specific silane, or a condensate thereof, and water; and a substrate with a coating film, which comprises a substrate and a coating film comprising a hydrolysable silane or a condensate thereof formed on a surface of the substrate, wherein the content of silicon atoms in the coating film to the total mass of the coating film is from 0.01 to 10 mass %, and the molar ratio of fluorine atoms to silicon atoms in the coating film surface is from 1 to 300.

This application is a continuation of PCT Application No. PCT/JP2018/025745, filed on Jul. 6, 2018, which is based upon and claims the benefit of priority from Japanese Patent Application No. 2017-133707 filed on Jul. 7, 2017. The contents of those applications are incorporated herein by reference in their entireties.

### TECHNICAL FIELD

The present invention relates to an aqueous coating material capable of forming a coating film which is excellent in the weather resistance and has a stable coating film surface such that the discoloration and the deterioration of gloss over time are suppressed, a method for producing a substrate with a coating film, and a substrate with a coating film.

### BACKGROUND ART

In the field of the coating material, from the viewpoint of environmental protection, an aqueous coating material comprising particles of a fluorinated polymer, which comprises a fluorinated polymer as a coating resin and water as a coating solvent is becoming widely used rapidly (Patent Document 1).

### PRIOR ART DOCUMENTS

### Patent Documents

Patent Document 1: JP-A-2014-088495

### DISCLOSURE OF INVENTION

### Technical Problem

In the above aqueous coating material, the fluorinated polymer dispersed in the form of particles is packed to form a coating film. Thus, there are problems such that the weather resistance of the fluorinated polymer is not expressed, and the weather resistance of a coating film thereby deteriorates in some cases, or an outer appearance of the coating film surface is unstable in some cases such that the discoloration on the coating film surface over time results, or the gloss deteriorates.

The present inventors have found that of a coating film formed of the aqueous coating material disclosed in Patent Document 1, the weather resistance is insufficient yet, a coating film surface is discolored, and the gloss deteriorates.

### Solution to Problem

As a result of extensive studies, the present inventors have found that a coating film which is excellent in the weather resistance and has a stable outer appearance of a coating film surface can be formed by blending specific hydrolysable silanes in combination in the above aqueous coating material or blending a condensate thereof.

That is, the present invention has the following features.

[1] An aqueous coating material comprising particles of a fluorinated polymer having units based on a fluoroolefin and units having a hydrophilic group; at least one hydrolysable silane selected from the group consisting of hydrolysable silanes represented by the following formulae 1 to 3 and a hydrolysable silane represented by the following formula 4, or a condensate of at least one hydrolysable silane selected from the group consisting of hydrolysable silanes represented by the following formulae 1 to 3 and a hydrolysable silane represented by the following formula 4; and water:

NH₂—Q¹—Z¹ (Formula 1)

NH₂—X²—NH—Q²—Z² (Formula 2)

NH(—Q³—Z³)₂ (Formula 3)

R⁴—Q⁴—Z⁴ (Formula 4)

wherein Q¹, Q², Q³ and Q⁴ which are independent of one another, is a C₃₋₁₈ alkylene group or a C₃₋₁₈ alkylene group having an etheric oxygen atom, X² is a C₁₋₁₈ alkylene group, Z¹, Z², Z³ and Z⁴ which are independent of one another, is a hydrolysable silyl group, and R⁴ is a hydrogen atom, a vinyl group, an epoxy group, a methacryloyloxy group, an acryloyloxy group, a ureide group, a mercapto group or an isocyanate group.

[2] The aqueous coating material according to the above [1], wherein R⁴ is a hydrogen atom or a methacryloyloxy group.
[3] The aqueous coating material according to the above [1] or [2], wherein the molar ratio of fluorine atoms to silicon atoms in the aqueous coating material is from 1 to 300.
[4] The aqueous coating material according to any of the above [1] to [3], wherein the hydrophilic group is a hydroxy group, a carboxy group or an amino group.
[5] The aqueous coating material according to any of the above [1] to [4], which contains at least one hydrolysable silane selected from the group consisting of hydrolysable silanes represented by the formulae 1 to 3 and the hydrolysable silane represented by the formula 4, or the condensate of the hydrolysable silanes in an amount of from 0.1 to 10 mass % to the total mass of the fluorinated polymer.
[6] The aqueous coating material according to any of the above [1] to [5], wherein R⁴ is a hydrogen atom, and Q⁴ is a C₄₋₁₀ alkylene group.
[7] The aqueous coating material according to any of the above [1] to [6], which further contains an inorganic pigment.
[8] The aqueous coating material according to the above [7], wherein the mass ratio of at least one hydrolysable silane selected from the group consisting of hydrolysable silanes represented by the formulae 1 to 3 and the hydrolysable silane represented by the formula 4, or the condensate of at least one hydrolysable silane selected from the group consisting of hydrolysable silanes represented by the formulae 1 to 3 and the hydrolysable silane represented by the formula 4 to the total mass of the inorganic pigment is from 0.01 to 0.10.
[9] The aqueous coating material according to the above [7] or [8], wherein the inorganic pigment is a titanium oxide pigment.
[10] The aqueous coating material according to any of the above [7] to [9], wherein the inorganic pigment is a titanium oxide pigment having a titanium oxide content of from 80 to 95 mass %.
[11] The aqueous coating material according to any of the above [1] to [10], which is used for coating a ceramic building material.
[12] The aqueous coating material according to any of the above [1] to [10], which is used as a heavy duty coating material.
[13] A method for producing a substrate with a coating film, which comprises applying the aqueous coating material as defined in any of the above [1] to [12] on a surface of a substrate to form a coating layer and drying the coating layer to form a coating film.
[14] A substrate with a coating film, which comprises a substrate and a coating film formed of the aqueous coating material as defined in any of the above [1] to [12] on the substrate, wherein the content of silicon atoms in the coating film to the total mass of the coating film is from 0.01 to 10 mass %, and the molar ratio of fluorine atoms to silicon atoms in the coating film is from 1 to 300.
[15] The substrate with a coating film according to the above [14], wherein the pencil hardness is from 4B to H, which is measured in accordance with JIS K 5600-5-4 (2009).

### Advantageous Effects of Invention

According to the present invention, an aqueous coating material, capable of forming a coating film which is excellent in the weather resistance and has a stable coating film surface such that the discoloration and the deterioration of gloss over time on the coating film surface are suppressed, can be provided. Further, according to the present invention, a substrate with a coating film which is excellent in the weather resistance and has a stable coating film surface such that the discoloration and the deterioration of gloss over time on the coating film surface are suppressed, can be provided.

### DESCRIPTION OF EMBODIMENTS

Meanings of terms in the present invention are as follows.

A “unit” refers to an atomic group directly formed by polymerization of a monomer and based on one molecule of the monomer and an atomic group obtained by chemically converting a part of the above mentioned atomic group. The content (mol %) of each type of units to all units contained in a fluorinated polymer can be determined by a charged amount of components used for preparing the fluorinated polymer.

A “hydrolysable silane” is a compound having a hydrolysable silyl group which is a group capable of forming a silanol group (—Si—OH group) by a hydrolytic reaction. The hydrolysable silyl group may, for example, be an alkoxysilyl group.

A “number average molecular weight” is a value measured by gel permeation chromatography using a polystyrene as the standard reference material. The “number average molecular weight” may be referred to as “Mn”.

An “acid value” and a “hydroxy value” are values measured in accordance with the method of JIS K 0070-3 (1992) respectively.

A “lowest film formation temperature” is the lowest temperature at which a uniform coating film can be formed without cracks, when drying a fluorinated polymer. In the present invention, the lowest film formation temperature is a value measured by means of a film formation temperature measuring apparatus IMC-1535 type (manufactured by Imoto Machinery Co., Ltd.).

An “average particle size” of particles is a value of D50 obtained by dynamic light scattering method. Further, D50 means a diameter of particles of volume cumulative 50 vol % counted from the small particle side in the particle size distribution of particles obtained by dynamic light scattering method (in Examples, ELS-8000 (manufactured by Otsuka Electronics Co., Ltd.) was used).

The mass of solid contents is, in a case where a coating material contains a solvent, the mass obtained by removing the solvent from the coating material. Here, components constituting solid contents of a coating material other than a solvent, are considered as solid contents, even if they are in a liquid state. Further, the mass of solid contents of a coating material is obtained as the mass remaining after heating the coating material at 130° C. for 20 minutes.

The aqueous coating material of the present invention comprises the after-mentioned fluorinated polymer, at least one hydrolysable silane (hereinafter referred to also as “aminosilane”) selected from the group consisting of hydrolysable silanes represented by the after-mentioned formulae 1 to 3 and a hydrolysable silane (hereinafter referred to also as “specific silane”) represented by the after-mentioned formula 4, or a condensate thereof, and water. In the aqueous coating material of the present invention, particles of a fluorinated polymer and particles of a modified (meth)acrylic polymer are dissolved or dispersed in water as a solvent.

In this specification, the aminosilane and the specific silane, and the condensate thereof are collectively referred to as “silane compound”. The aqueous coating material of the present invention comprising a silane compound means any of a case of containing an aminosilane and a specific silane, a case of containing a condensate of an aminosilane and a specific silane and a case of containing an aminosilane, a specific silane and a condensate of an aminosilane and a specific silane.

A coating film which is excellent in the weather resistance and has a stable surface such that the discoloration and the deterioration of gloss are suppressed, can be formed with the aqueous coating material of the present invention. The reason is not clearly understood, however, the following is considered.

The fluorinated polymer has high hydrophobicity, whereby the dispersion stability and the uniformity of particles of the fluorinated polymer in an aqueous coating material are low. Thus, a coating film of the aqueous coating material, which is formed by packing particles of the fluorinated polymer tends to be non-uniform, and the discoloration and the deterioration of gloss tend to result.

Here, the present inventors have found that by blending an aminosilane and a specific silane in combination in an aqueous coating material containing a fluorinated polymer, the weather resistance of a coating film to be formed is excellent, and the stability of a coating film surface is improved.

The reason why the above-mentioned excellent aqueous coating material can be obtained is not clear, however, the following is considered. The silane compound in the present invention has an affinity with both water and a fluorinated polymer. Thus, it is considered that when packing particles of a fluorinated polymer for forming a coating film, the above-mentioned silane compound is present in the vicinity of the fluorinated polymer, whereby the uniformity of a coating film is improved. As a result, a coating film formed with the aqueous coating material of the present invention is excellent in the weather resistance, and the discoloration and the deterioration of gloss are suppressed.

The fluorinated polymer in the present invention has units based on a fluoroolefin (hereinafter referred to also as “units F”) and units having a hydrophilic group (hereinafter referred to also as “units 1”).

The fluoroolefin is an olefin of which at least one hydrogen atom is substituted by a fluorine atom. In the fluoroolefin, at least one hydrogen atom which is not substituted by a fluorine atom may be substituted by a chlorine atom.

The fluoroolefin may, for example, be CF₂═CF₂, CF₂═CFCl, CF₂═CHF, CH₂═CF₂, CF₂═CFCF₃, CF₃—CH═CHF or CF₃—CF═CH₂. From the viewpoint of the weather resistance of a coating film (hereinafter referred to also as the present coating film) to be formed with the aqueous coating material of the present invention, CF₂═CF₂ or CF₂═CFCl is more preferred, CF₂═CFCl is particularly preferred. As the fluoroolefin, two or more types may be used in combination.

The content of the units F is preferably from 20 to 70 mol %, more preferably from 30 to 60 mol %, particularly preferably from 45 to 55 mol %, to all units in the fluorinated polymer, from the viewpoint of the dispersion stability of the fluorinated polymer and the weather resistance of the present coating film.

The units 1 may be units based on a monomer having a hydrophilic group or may be units obtained by converting hydrophilic groups in the fluorinated polymer having the units 1 into different hydrophilic groups. Such units may, for example, be units obtained by reacting a fluorinated polymer having units having a hydroxy group with a polycarboxylic acid, an acid anhydride thereof or the like to convert a part of or all of hydroxy groups to carboxy groups. Here, the units 1 do not have a fluorine atom.

The hydrophilic group in the units 1 is preferably a hydroxy group, a carboxy group or an amino group, and from the viewpoint of the affinity between the fluorinated polymer and the silane compound, a hydroxy group or a carboxy group is particularly preferred.

The monomer having a hydroxy group may, for example, be allyl alcohol, or a vinyl ether, a vinyl ester, an allyl ether, an allyl ester or a (meth)acrylate, which has a hydroxy group. The monomer having a hydroxy group is preferably an allyl alcohol or a monomer represented by the formula X¹—Z¹.

X¹ is CH₂═CHC(O)O—, CH₂═C(CH₃)C(O)O—, CH₂═CHOC(O)—, CH₂═CHCH₂OC(O)—, CH₂═CHO— or CH₂═CHCH₂O—, and CH₂═CHO— or CH₂═CHCH₂O— is preferred.

Z¹ is a C₂₋₄₂ monovalent organic group having a hydroxy group. The organic group may be linear or branched. Further, the organic group may consist of a cyclic structure or may have a cyclic structure.

The organic group is preferably a C₂₋₆ alkyl group having a hydroxy group, an alkyl group having a C₆₋₈ cycloalkylene group having a hydroxy group or a polyoxyalkylene group having a hydroxy group.

In a case where two or more types of monomers having a hydroxy group are used in combination, from the viewpoint of the affinity between the fluorinated polymer and the silane compound, at least one type is preferably a monomer having a polyoxyalkylene group having a hydroxy group. That is, in such a case, the units C preferably contain units based on a monomer having a polyoxyalkylene group having a hydroxy group. The molar ratio of the units based on a monomer having a polyoxyalkylene group having a hydroxy group to the units C (units based on a monomer having a polyoxyalkylene group having a hydroxy group/units C) is preferably from 0.01 to 1.0, more preferably from 0.03 to 0.50.

As specific examples of the monomer having a hydroxy group, CH₂═CHCH₂OH, CH₂═CHOCH₂-cycloC₆H₁₀—CH₂OH, CH₂═CHCH₂OCH₂-cycloC₆H₁₀—CH₂OH, CH₂═CHOCH₂CH₂OH, CH₂═CHCH₂OCH₂CH₂OH, CH₂═CHOCH₂CH₂CH₂CH₂OH, CH₂═CHCH₂OCH₂CH₂CH₂CH₂OH, CH₂═CHOCH₂-cycloC₆H₁₀—CH₂(OCH₂CH₂)₁₀OH, CH₂═CHOCH₂-cycloC₆H₁₀—CH₂(OCH₂CH₂)₁₅OH, CH₂═CHCOOCH₂CH₂OH and CH₂═C(CH₃)COOCH₂CH₂OH, may be mentioned. Here, “-cycloC₆H₁₀—” is a cyclohexylene group, and the bonding part of “-cycloC₆H₁₀—” is usually 1,4-.

The monomer having a carboxy group may, for example, be an unsaturated carboxylic acid or a (meth)acrylic acid. The monomer having a carboxy group is preferably a monomer represented by the formula X²—Z².

X² is CH₂═CH—, CH(CH₃)═CH— or CH₂═C(CH₃)—, preferably CH₂═CH— or CH(CH₃)═CH—.

Z² is a carboxy group or a C₁₋₁₂ monovalent saturated hydrocarbon group having a carboxy group, preferably a carboxy group or a C₁₋₁₀ carboxyalkyl group.

As specific examples of the monomer having a carboxy group, CH(CH₃)═CHCOOH, CH₂═CHCOOH, CH₂═C(CH₃)COOH and a compound represented by the formula CH₂═CH(CH₂)ₙ₂₁COOH (wherein n21 is an integer of from 1 to 10, and preferably CH₂═CHCH₂COOH or CH₂═CH(CH₂)₈COOH) may be preferably mentioned.

The content of the units 1 is preferably from 0.1 to 35 mol %, more preferably from 1 to 20 mol % to all units in the fluorinated polymer, from the viewpoint of the affinity between the fluorinated polymer and the silane compound.

As the monomer 1, two or more types may be used in combination.

The hydrophilic group in the units 1 may be a crosslinkable group.

In a case where the hydrophilic group is a hydroxy group, the aqueous coating material of the present invention preferably contains an isocyanate type curing agent (compound having at least 2 isocyanate groups) as a curing agent from the viewpoint of the weather resistance of the present coating film.

In a case where the hydrophilic group is a carboxy group, the aqueous coating material of the present invention preferably contains a carbodiimide type curing agent (compound having at least 2 carbodiimide groups), an amine type curing agent (compound having at least 2 amino groups), an oxazoline type curing agent (compound having at least 2 oxazoline groups) or an epoxy type curing agent (compound having at least 2 epoxy groups) as a curing agent from the viewpoint of the weather resistance of the present coating film.

The fluorinated polymer in the present invention may further have units (hereinafter referred to also as units 2) other than the units F and the units 1.

The units 2 are units based on a monomer (hereinafter referred to also as monomer 2) other than units F and the units 1. The monomer 2 may, for example, be a vinyl ether, a vinyl ester, an allyl ether, an allyl ester or a (meth)acrylate, which has no hydrophilic group nor fluorine atom.

The monomer 2 is preferably at least one type selected from the group consisting of a vinyl ether having an alkyl group, a vinyl ester having an alkyl group, an allyl ether having an alkyl group, an allyl ester having an alkyl group and a (meth)acrylate having an alkyl group. Either one or both of an alkyl vinyl ether and an alkyl vinyl ester are particularly preferred with a view to suppressing the discoloration of the present coating film. In a case where the aqueous coating material of the present invention contains an inorganic pigment, the number of carbon atoms of the alkyl group is preferably from 1 to 12, particularly preferably from 1 to 8, whereby the dispersion property of the inorganic pigment will be excellent.

The alkyl group in the monomer having an alkyl group may be linear or branched. Here, the alkyl group is a group having no cyclic structure.

As the alkyl group in the monomer having an alkyl group, a methyl group, an ethyl group, a propyl group, a butyl group, a 2-ethylhexyl group, a neononyl group or a neodecanyl group may be mentioned. The alkyl group in the monomer having an alkyl group is preferably a C₁₋₄ linear alkyl group from the viewpoint of excellent storage stability of the aqueous coating material of the present invention.

As specific examples of the monomer 2, ethyl vinyl ether, tert-butyl vinyl ether, 2-ethylhexyl vinyl ether, cyclohexyl vinyl ether, vinyl acetate, vinyl pivalate, vinyl neononanoate (“VeoVa 9”, tradename of HEXION), vinyl neodecanoate (“VeoVa 10”, tradename of HEXION), benzoic acid vinyl ester tert-butyl (meth)acrylate and benzyl (meth)acrylate may be mentioned. As the monomer 2, two or more types may be used in combination.

In a case where the fluorinated polymer has the units 2, the content of the units 2 is preferably higher than 0 mol % and at most 60 mol %, particularly preferably from 5 to 40 mol %, to all units in the fluorinated polymer, from the viewpoint of the reactivity with the units F and the units 1. Further, in a case where the fluorinated polymer has units 2 having a C₁₋₄ linear alkyl group, the content of the units 2 having a C₁₋₄ linear alkyl group is preferably higher than 0 mol % and at most 60 mol %, particularly preferably from 20 to 40 mol %, to all units in the fluorinated polymer, from the viewpoint of excellent storage stability of the aqueous coating material of the present invention.

From the viewpoint of the film formation property of the present coating film, the fluorinated polymer preferably has a content of the units F of from 20 to 70 mol %, a content of the units 1 of from 0.1 to 35 mol % and a content of the units 2 of from 0 to 60 mol %, to all units in the fluorinated polymer.

In a case where the fluorinated polymer of the present invention has a hydroxy value, the hydroxy value is preferably from 1 to 80 mgKOH/g, more preferably from 5 to 70 mgKOH/g, particularly preferably from 15 to 60 mgKOH/g.

In a case where the fluorinated polymer has an acid value, the acid value is preferably from 1 to 80 mgKOH/g, more preferably from 5 to 70 mgKOH/g, particularly preferably from 15 to 60 mgKOH/g.

When the hydroxy value and the acid value fall within the above ranges, in a case where the aqueous coating material of the present invention contains an inorganic pigment, the fluorinated polymer and the inorganic pigment are suitably arranged, whereby the weather resistance of the present coating film will further improve.

The lowest film formation temperature of the fluorinated polymer is preferably from 0 to 60° C., more preferably from 10 to 40° C., further preferably from 20 to 35° C., whereby the present coating film is made to be dense.

As the method for producing the fluorinated polymer, a method of polymerizing a fluoroolefin and the monomer 1 in the presence of water and a polymerization initiator, may be mentioned. As a specific example of the polymerization method in the method for producing the fluorinated polymer, an emulsion polymerization method may be mentioned. By the emulsion polymerization method, an aqueous dispersion having the fluorinated polymer dispersed in the form of particles in water can be obtained.

In the polymerization, as a case requires, a surfactant, a molecular weight modifier (such as dodecyl mercaptan or butyl mercaptan), a pH adjuster or the like may be added.

The fluorinated polymer is dispersed in the form of particles in water. The average particle size of the particles of the fluorinated polymer is preferably at most 200 nm, more preferably at most 190 nm, particularly preferably at most 185 nm from the viewpoint of the water resistance of the present coating film. The above-mentioned average particle size is usually at least 50 nm.

The content of the fluorinated polymer in the aqueous coating material of the present invention is preferably from 10 to 90 mass %, more preferably from 20 to 80 mass %, to the total mass of the aqueous coating material, from the viewpoint of the weather resistance of the present coating film.

The aminosilane in the present invention is at least one hydrolysable silane selected from the group consisting of hydrolysable silanes represented by the following formulae 1 to 3.

NH₂—Q¹—Z¹ (Formula 1)

NH₂—X²—NH—Q²—Z² (Formula 2)

NH(—Q³—Z³)₂ (Formula 3)

Meanings of symbols in the formulae are as follows.

Each of Q¹, Q² and Q³ which are independent of one another, is a C₃₋₁₈ alkylene group or a C₃₋₁₈ alkylene group having an etheric oxygen atom, preferably a C₃₋₁₈ alkylene group. X² is a C₁₋₁₈ alkylene group, preferably a C₂₋₁₂ alkylene group.

Each of Z¹, Z² and Z³ which are independent of one another, is a hydrolysable silyl group, preferably a trialkoxysilyl group, particularly preferably a trimethoxysilyl group or a triethoxysilyl group.

As specific examples of the aminosilane, bis(triethoxysilylpropyl)amine, 3-aminopropyltriethoxysilane, 3-aminopropyltrimethoxysilane and N-(2-aminoethyl)-3-aminopropyltrimethoxysilane may be mentioned.

Two or more types of the aminosilane may be used in combination.

The aqueous coating material of the present invention contains the aminosilane in an amount of preferably from 10 to 90 parts by mass, particularly preferably from 20 to 80 parts by mass, per 100 parts by mass of the silane compound, from the viewpoint of the affinity with the hydrophilic groups in the fluorinated polymer, particularly in a case where the aqueous coating material of the present invention contains an inorganic pigment, from the viewpoint of the affinity with the inorganic pigment.

The specific silane in the present invention is a hydrolysable silane represented by the following formula 4.

R⁴—Q⁴—Z⁴ (Formula 4)

Meanings of symbols in the formula are as follows.

Q⁴ is a C₃₋₁₈ alkylene group or a C₃₋₁₈ alkylene group having an etheric oxygen atom, preferably a C₃₋₁₈ alkylene group.

Z⁴ is a hydrolysable silyl group, preferably a trialkoxysilyl group, particularly preferably a trimethoxysilyl group or a triethoxysilyl group.

R⁴ is a hydrogen atom, a vinyl group, an epoxy group, a methacryloyloxy group, an acryloyloxy group, a ureido group, a mercapto group or an isocyanate group, preferably a hydrogen atom or the methacryloyloxy group, particularly preferably a hydrogen atom.

The specific silane in the present invention is preferably an alkyl alkoxysilane or a methacryloyloxyalkyl alkoxysilane, and with a view to suppressing the discoloration of the present coating film, the alkyl alkoxysilane is particularly preferred.

The alkyl alkoxysilane is preferably a monoalkyl trialkoxysilane, a dialkyl dialkoxysilane or a trialkyl monoalkoxysilane. Particularly, in a case where the aqueous coating material of the present invention contains an inorganic pigment, the monoalkyl trialkoxysilane is particularly preferred, whereby the surface of the inorganic pigment can be highly covered, and the hydrophobicity of the inorganic pigment can be controlled.

The alkoxy group in the alkyl alkoxysilane is preferably a C₁₋₃ alkoxy group, particularly preferably a methoxy group or an ethoxy group.

The alkyl group in the alkyl alkoxysilane is a C₃₋₁₈ alkyl group, preferably a C₃₋₁₂ alkyl group, further preferably a C₄₋₁₀ alkyl group, particularly preferably a C₄₋₅ alkyl group, whereby the discoloration of the present coating film is suppressed.

As specific examples of the alkyl alkoxysilane, methyl triethoxysilane, n-propyl trimethoxysilane, isobutyl trimethoxysilane, octyl trimethoxysilane and hexadecyl trimethoxysilane may be mentioned.

Particularly in a case where the aqueous coating material of the present invention contains an inorganic pigment, the methacryloyloxyalkyl alkoxysilane is preferably a monomethacryloyloxyalkyl alkoxysilane, whereby the surface of the inorganic pigment can be highly covered, and the hydrophobicity of the inorganic pigment can be controlled.

The alkoxy group in the methacryloyloxyalkyl alkoxysilane is preferably a C₁₋₃ alkoxy group, particularly preferably a methoxy group or an ethoxy group.

As specific examples of the methacryloyloxyalkyl alkoxysilane, 3-methacryloyloxypropyl dimethoxysilane, 3-methacryloyloxypropyl trimethoxysilane, 3-methacryloyloxypropyl methyl diethoxysilane and 3-methacryloyloxypropyl triethoxysilane may be mentioned.

As other specific examples of the specific silane, an alkoxysilane having an epoxy group such as 3-glycidyloxypropyl trimethoxysilane, an alkoxysilane having a mercapto group such as 3-mercaptopropyl trimethoxysilane, an alkoxysilane having an ureido group such as 3-ureidopropyl triethoxysilane and an alkoxysilane having an isocyanate group such as 3-isocyanatepropyl triethoxysilane may be mentioned. Two or more types of the specific silane may be used in combination.

In the aqueous coating material of the present invention, the ratio of fluorine atoms to silicon atoms (hereinafter referred to also as “F/Si” ratio) is preferably from 1 to 300, more preferably from 10 to 100, particularly preferably from 15 to 70. When F/Si in the aqueous coating materials falls within the above range, the fluorinated polymer, and the aminosilane and the specific silane or a condensate thereof suitably interact with each other. Further, this effect is particularly remarkable when the aqueous coating material of the present invention contains an inorganic pigment.

Further, F/Si ratio in the aqueous coating material of the present invention is a ratio of the total molar amount of fluorine atoms in the fluorinated polymer contained in the aqueous coating material to the total molar amount of silicon atoms in the compound having a silicon atom contained in the aqueous coating material.

Further, in the aqueous coating material of the present invention, the total content of the silane compound is preferably from 0.01 to 50 mass %, more preferably from 0.1 to 30 mol %, particularly preferably from 1 to 20 mol %, to the total mass of the fluorinated polymer, from the viewpoint of the affinity with the fluorinated polymer.

The aqueous coating material of the present invention preferably contains an inorganic pigment. In such a case, the design property of the present coating film is improved, and the anticorrosive property is improved as compared with a case of containing an organic pigment or the like, whereby the aqueous coating material of the present invention is suitable as a coating material to be used for ceramic building materials and a heavy-duty coating material.

According to the knowledge of the present inventors, the effect of the present invention is further remarkably particularly in a case where the aqueous coating material of the present invention contains an inorganic pigment.

That is, an aqueous coating material containing a fluorinated polymer and an inorganic pigment may deteriorate due to a chemical function of the inorganic pigment in some cases. For example, if the inorganic pigment is activated or oxidized by solar light or ultraviolet ray, the fluorinated polymer may sometimes deteiorate by activated species thereby formed. Such deterioration phenomena tend to occur if the inorganic pigment is unevenly located in a coating film, and as a result, chalking results on the coating film, and the coating film surface deteriorates.

On the other hand, the silane compound in the present invention has a high affinity with the inorganic pigment and has a C₃₋₁₈ alkylene group which may have an etheric oxygen atom. Accordingly, it is considered that in the aqueous coating material of the present invention, the silane compound is densely located on a surface of the inorganic pigment. Particularly, it is considered that the surface of the inorganic pigment is covered with alkylene groups (alkyl groups in a case where R⁴ is a hydrogen atom) of the specific silane among silane compounds. Further, it is considered that the amino groups of the aminosilane, which is densely located on the surface of the inorganic pigment are located in the outermost surface (water side), whereby not only the dispersion stability of the inorganic pigment in the aqueous coating material is improved, but also the amino groups have an affinity with hydrophilic groups in the fluorinated polymer, whereby the affinity of the fluorinated polymer and the inorganic pigment is improved. As a result, it is considered that in a coating film to be formed with the aqueous coating material of the present invention, the inorganic pigment is uniformly dispersed without being unevenly localized, and the affinity with the fluorinated polymer is good, whereby the inorganic pigment is less likely to be exposed on the coating film surface, and the deterioration of the coating film surface due to chalking of the coating film is suppressed.

That is, an aqueous coating material contains an inorganic pigment for the design property in many cases. According to the present invention, even if the inorganic pigment is contained, an aqueous coating material whereby a coating film which can maintain good design property and weather resistance for a long period of time can be formed, is provided.

The above effect is particularly remarkable in a case where the inorganic pigment is a titanium oxide pigment which is a pigment having a photocatalytic activity.

The inorganic pigment may, for example, be a luster pigment, an anti-corrosive pigment, a coloring pigment or an extender.

The luster pigment is a pigment to impart brightness to a coating film, and an aluminum powder, a nickel powder, a stainless steel powder, a copper powder, a bronze powder, flour gold, a silver powder, a mica powder, a graphite powder, glass flakes or a scaly iron oxide powder is preferred.

The anti-corrosive pigment is a pigment to impart an anti-corrosive property to a substrate, a leadless anti-corrosive pigment is preferred, and zinc cyanamide, zinc oxide, zinc phosphate, calcium magnesium phosphate, zinc molybdate or barium borate is preferred.

The coloring pigment is a pigment for coloring a coating film, and titanium oxide and iron oxide are preferred.

The extender is a pigment for improving hardness of a coating film and increasing the film thickness of the coating film, and talc, barium sulfate, mica or the like is preferred.

Two or more types of the inorganic pigment may be used in combination.

The inorganic pigment is preferably a titanium oxide pigment from the viewpoint of the design property, and from the viewpoint of the weather resistance, a titanium oxide pigment having a titanium oxide content of from 80 to 95 mass % is more preferred. Specifically, the titanium oxide pigment is preferably a titanium oxide pigment which is surface-treated with silica, alumina, zirconia, selenium or a polyol, particularly preferably a titanium oxide pigment of which the titanium oxide content is adjusted to from 80 to 95 mass % by the surface treatment.

When the titanium oxide pigment has a titanium oxide content within the above range, the design property and the weather resistance of the present coating film are excellent, and the silane compound can be easily located on the surface of the titanium oxide pigment.

In a case where the aqueous coating material of the present invention contains an inorganic pigment, from the viewpoint of the design property of the present coating film and the compatibility with the fluorinated polymer, the content of the inorganic pigment is preferably from 0.01 to 90 mass %, more preferably from 0.1 to 80 mass %, further preferably from 1 to 70 mass %, particularly preferably from 30 to 60 mass %, to the total mass of the fluorinated polymer.

In a case where the aqueous coating material of the present invention contains the inorganic pigment, the mass ratio of the silane compound to the total mass of the inorganic pigment (mass of the silane compound/mass of the inorganic pigment) is preferably from 0.001 to 1.0, particularly preferably from 0.01 to 0.10. When the mass ratio falls within the above range, the surface of the inorganic pigment can be suitably covered with the silane compound, whereby the weather resistance of the present coating film will be further good, and the discoloration and the deterioration of gloss over time of the present coating film surface can be further suppressed.

Water in the aqueous coating material of the present invention is a dispersion medium for dispersing components such as the fluorinated polymer. The dispersion medium preferably consists solely of water or is a mixed solvent comprising water and a water-soluble organic solvent. In the latter case, the content of the water-soluble organic solvent is preferably at most 5 mass %, more preferably at most 1 mass %, particularly preferably at most 0.5 mass %, to the total mass of water. As specific examples of the water-soluble organic solvent, methanol, ethanol, butanol, acetone and methyl ethyl ketone may be mentioned.

The aqueous coating material of the present invention may contain various additives, as the case requires.

As specific examples of the additive, a polymer other than the fluorinated polymer of the present invention (such as a fluorinated polymer other than the fluorinated polymer of the present invention, a polyester, a polyacrylate, a polymethacrylate or a polyurethane), a silane compound other than the silane compound of the present invention (such as silica sol), a surfactant, a curing agent, an organic pigment, a dispersing agent, an antifoaming agent, a film forming assistant, a levelling agent, a thickener, a curing assistant, a light stabilizer, a UV absorber, a surface modifier and an anti-staining agent may be mentioned.

Here, in a case where the aqueous coating material of the present invention contains a silane compound other than the silane compound of the present invention, the silane compound may be condensed alone, may be condensed with the aminosilane of the present invention and the specific silane or may be condensed with either the aminosilane of the present invention or the specific silane.

As described above, from the viewpoint of the weather resistance of the present coating film, the aqueous coating material of the present invention preferably contains a curing agent which is a compound having at least 2 groups which react with the hydrophilic groups in the fluorinated polymer. Further, from the viewpoint of the weather resistance of the present coating film, the aqueous coating material of the present invention preferably contains a UV absorber.

As the method for producing the aqueous coating material of the present invention, the following method may be mentioned.

First, a fluoroolefin and the monomer 1 are polymerized in the presence of water and a polymerization initiator to obtain an aqueous dispersion containing a fluorinated polymer. The aqueous dispersion having the fluorinated polymer dispersed in the form of particles is mixed with the aminosilane, the specific silane and an inorganic pigment to obtain an aqueous coating material of the present invention.

The aqueous coating material of the present invention may be directly applied on a surface of a substrate or may be applied on a surface of a substrate which is surface-treated (undercoating treatment or the like). From the viewpoint of the weather resistance of the present coating film, the thickness of the coating film is preferably from 25 to 100 μm, more preferably from 30 to 80 μm.

As specific examples of the material of the substrate, a non-metal material (such as an organic material such as a resin, a rubber or wood or an inorganic material such as concrete, glass, ceramics or stone) and a metal material (such as iron, an iron alloy, aluminum or an aluminum alloy) may be mentioned.

As specific examples of the method of applying the aqueous coating material of the present invention, a method of using a coating tool such as a brush, a roller, dipping, a spray, a roll coater, a die coater, an applicator or a spin coater may be mentioned.

The present coating film is preferably formed by applying the aqueous coating material to form a coating layer, and drying the obtained coating layer. The drying temperature after coating is preferably from 0 to 50° C. The present coating film may be formed by forming a coating layer and drying it, followed by heat curing as the case requires. The heat curing temperature is preferably from 50 to 200° C. The drying time is usually from 30 minutes to 2 weeks, and the heat curing time is usually from 1 minute to 24 hours.

The substrate with a coating film obtained by the above production method has a substrate and a coating film formed of the aqueous coating material of the present invention on the surface of the substrate. The substrate with a coating film is useful as a substrate to be used in applications of ceramic building materials and heavy-duty coating which are required to have the weather resistance for a long period of time, since the weather resistance is excellent, and the deterioration of the film over time is suppressed. Particularly, in a case where the substrate with a coating film contains an inorganic pigment, the substrate with a coating film is useful as a substrate to be used in applications of ceramic building materials and heavy-duty coating which are required to have the weather resistance and a high design property. The aqueous coating material of the present invention is particularly useful as a coating material to be used for coating ceramic building materials and as a heavy-duty coating material.

According to the present invention, a substrate with a coating film which comprises a substrate and a coating film containing a silane compound, formed on the surface of the substrate, wherein the content of silicon atoms is from 0.01 to 10 mass % to the total mass of the coating film, and the molar ratio of fluorine atoms to silicon atoms in the coating film is from 1 to 300, is provided.

Here, the content of silicon atoms in the coating film is the content (mass %) of silicon atoms to the total mass of the coating film and can be obtained as the content (mass %) of silicon atoms contained in the coating film to the mass of solid components of a coating material to form the coating film. The content of silicon atoms in the coating film can be controlled by the type and the mass of the silane compound to be contained in the coating film or the coating material.

Here, the molar ratio of fluorine atoms to silicon atoms in the coating film has the same meaning as F/Si ratio in the above mentioned aqueous coating material.

The molar ratio of fluorine atoms to silicon atoms in the surface of the present coating film is preferably higher than the above-mentioned F/Si ratio. The molar ratio of fluorine atoms to silicon atoms in the surface of the present coating film can be obtained by analyzing the coating film surface by the energy dispersive X-ray spectroscopy by means of a scanning electron microscope and is a ratio of X-ray intensity derived from fluorine atoms to X-ray intensity derived from silicon atoms (hereinafter referred to also as “Fₓ/Siₓ ratio”). Fₓ/Siₓ ratio can be controlled by types, the mass, etc. of the fluorinated polymer and the silane compound to be contained in the coating film.

When the present coating film contains an inorganic pigment and has a higher Fₓ/Siₓ ratio than F/Si ratio, the inorganic pigment is less likely to be exposed on the present coating film surface. Accordingly, the present coating film is excellent in the weather resistance and has a coating film surface which is stable such that the discoloration and the deterioration of gloss over time are suppressed.

The content of silicon atoms in the present coating film is preferably from 0.01 to 10 mass %, more preferably from 0.1 to 1 mass %, with a view to improving non-adhesive property of the present coating film.

The pencil hardness of the present coating film measured in accordance with JIS K 5600-5-4 (2009) is from 4B to H, preferably from 3B to H, more preferably from 2B to B, from the viewpoint of the processability of the substrate with a coating film.

The substrate with a coating film of the present invention has a coating film containing a fluorinated polymer and a hydrolysable silane or a condensate of a hydrolysable silane wherein the amount of silicon atoms contained in the coating film and the amount of fluorine atoms and silicon atoms in the coating film surface are controlled within the predetermined ranges, whereby the weather resistance and the stability of the coating film surface are excellent. Particularly, when the coating film contains an inorganic pigment, the dispersibility of the inorganic pigment in the coating film is excellent, and the weather resistance and the stability of the design property for a long period of time are excellent.

### EXAMPLES

Now, the present invention will be described in detail with reference to Examples. However, the present invention is not limited to these Examples. Further, the blending amount of each component in the after-mentioned Table is represented by mass standard. Further, Ex. 1 to 4 and 6 are Examples of the present invention, and Ex. 5 is a Comparative Example.

### Abbreviations of Components Used for Producing Fluorinated Polymer

CF₂═CFCl: CTFE

Cyclohexanedimethanol monovinyl ether: CHMVE

CH₂═CHOCH₂-cycloC₆H₁₀—CH₂(OCH₂CH₂)₁₅OH: CM-15EOVE

Ethyl vinyl ether: EVE

2-Ethylhexyl vinyl ether: 2-EHVE

Cyclohexyl vinyl ether: CHVE

Surfactant 1: DKS NL-100 (polyoxyethylene alkyl ether, manufactured by DKS Co., Ltd.)

Surfactant 2: SLS (sodium lauryl sulfate)

### Hydrolysable Silane

Silane compound 1: a mixture of equivalent weight of 3-aminopropyl trialkoxysilane and isobutyl trialkoxysilane (including a condensate of 3-aminopropyl trialkoxysilane and isobutyl trialkoxysilane)

Silane compound 2: a mixture of equivalent weight of N-2-(aminoethyl)-3-aminopropyl trimethoxysilane and hexyl trimethoxysilane

Silane compound 3: a mixture of equivalent weight of N-2-(aminoethyl)-8-aminooctyl triethoxysilane and decyl trimethoxysilane.

Silane compound 4: a mixture of equivalent weight of γ-aminopropyl trimethoxysilane and γ-methacryloxypropyl trimethoxysilane

### Inorganic Pigment

Inorganic pigment: D-918 (tradename of Sakai Chemical Industry Co., Ltd., titanium oxide pigment having a titanium oxide content of 85%)

### Additive

Dispersing agent: BYK-190 (tradename of BYK Japan K.K.)

Anti-foaming agent: Dehydran 1620 (tradename of SAN NOPCO LIMITED)

Film forming assistant: Texanol (tradename of Eastman Chemical Company)

Levelling agent: BYK-348 (tradename of BYK Japan K.K.)

Thickener: ACRYSOL TT-935 (tradename of Dow Chemical Company)

### Preparation Example of Fluorinated Polymer 1

CTFE (466 g), CHMVE (150 g), CM-15EOVE (20 g), 2-EHVE (184 g), CHVE (242 g), deionized water (930 g), calcium carbonate (1.40 g), DKS NL-100 (47 g) and SLS (0.93 g) were charged in an autoclave with stirring, and the temperature was raised and maintained at 50° C.

Then, the polymerization was carried out for 24 hours, while continuously adding a 0.4 mass % aqueous solution (50 mL) of ammonium persulfate in the autoclave, and the solution in the autoclave was subjected to filtration to obtain an aqueous dispersion containing particles of the fluorinated polymer 1 (the concentration of the fluorinated polymer 1: 50 mass %).

The fluorinated polymer 1 had a hydroxy value of 47 mgKOH/g, the lowest film formation temperature was 32° C., and the average particle size of the particles of the fluorinated polymer 1 was 173 nm.

Further, the contents of the units based on CTFE, the units based on CHMVE, the units based on CM-EOVE, the units based on 2-EHVE and the units based on CHVE to all units in the fluorinated polymer were 50 mol %, 11 mol %, 0.3 mol %, 14.7 mol % and 24 mol %, respectively.

### Preparation Example of Fluorinated Polymer 2

An aqueous dispersion 2 containing particles of the fluorinated polymer 2 (the concentration of the fluorinated polymer 2: 50 mass %) was obtained in the same manner as in Preparation Example of fluorinated polymer 1, except that the types and the amounts of the monomers were changed to CTFE (532 g), EVE (249 g), 2-EHVE (143 g), CHMVE (31 g) and CM-15EOVE (19 g).

The fluorinated polymer 2 had a hydroxy value of 12 mgKOH/g, the lowest film formation temperature was 26° C., and the average particle size of the particles of the fluorinated polymer 2 was 150 nm.

The contents of the units based on CTFE, the units based on EVE, the units based on 2-EHVE, the units based on CHMVE and the units CM-EOVE to all units in the fluorinated polymer 2 were 50 mol %, 37.75 mol %, 10 mol %, 2 mol % and 0.25 mol %, respectively.

### Preparation Example of Pigment Dispersion

An inorganic pigment (72 g), a dispersing agent (5 g), an anti-foaming agent (0.5 g), deionized water (22.5 g) and glass beads (100 g) were mixed and dispersed by means of a rocking mill, and the glass beads were removed by filtration to prepare a pigment dispersion.

### Preparation Example of Aqueous Coating Material

The aqueous dispersion, the silane compound 1, the film forming assistant, the levelling agent, a thickener, the above-mentioned pigment dispersion and deionized water as the components of the aqueous coating material described in Table 1 were mixed in the amounts mentioned in Table 1 respectively to obtain aqueous coating materials 1 to 6 respectively.

### Preparation Example of Substrate with Coating Film

A surface of a slate plate having a length of 120 mm, a width of 60 mm and a thickness of 15 mm was coated with Miracsealer-eco (tradename of SK KAKEN CO., LTD.), followed by drying at 25° C. for 24 hours to obtain a slate plate having an undercoating film having a dry film thickness of 20 μm.

Then, the surface of the undercoating film was coated with each aqueous coating material by means of a glass rod and dried at room temperature for 14 days to obtain a slate plate having a coating film (dry film thickness of 40 μm) formed of each aqueous coating material. The obtained slate plates having a coating film were subjected to the following evaluations as test specimens 1 to 6 respectively.

### Evaluation

The above-mentioned respective aqueous coating materials and test specimens were subjected to the following evaluation methods to evaluate properties of the coating films. The results are shown in Table 1.

### Storage Stability of Aqueous Coating Material

Each aqueous coating material was put in a glass bottle, and the glass bottle was sealed and left to stand at 50° C. for 2 months. After 2 months, the color of the aqueous coating material was visually evaluated.

A: discoloration (yellowing) was not observed.

B: discoloration (yellowing) was slightly observed.

C: discoloration (yellowing) was observed.

### Weather Resistance of Coating Film

An exposure test was carried out by exposing the test specimen to xenon arc radiation by means of a xenon weather meter in accordance with JIS K 5600-7-7 (method 1) under the following test conditions. Here, a 1 mass % hydrogen peroxide solution was sprayed on the test specimen instead of water.

### Test Condition

Relative humidity: 70% RH

Black panel temperature: 50° C.

Irradiance of xenon arc radiation: 80 W/m² (from 300 to 400 nm)

Spraying 1 mass % hydrogen peroxide solution and drying: cycle of spraying time of 3 minutes and drying time of 2 minutes.

### Gloss Retention of Coating Film

The change of the gloss due to deterioration of the coating film surface over time was evaluated, based on the gloss retention (unit: %) which is the proportion of the value of the 60° glossiness of the coating film after xenon arc radiation for 80 hours to the value of 60° glossiness of the coating film immediately before xenon arc radiation being 100%. The gloss retention was measured and calculated in accordance with JIS K 5600-4-7: 1999 (ISO 2813: 1994).

S: the gloss retention of at least 60%

A: the gloss retention of at least 50% and less than 60%

B: the gloss retention of at least 40% and less than 50%

C: the gloss retention of at most 40%

### Discoloration of Coating Film

The colorimetry of the surface of the coating film immediately before xenon arc radiation and the colorimetry after xenon arc radiation for 40 hours were conducted by means of a color difference meter (SA4000, manufactured by NIPPON DENSHOKU INDUSTRIES, CO., LTD.). The measurements were carried out in accordance with JIS K 5600-4-5: 1999. Further, the color difference (ΔE) before and after radiation was calculated in accordance with JIS K 5600-4-6: 1999, and the degree of the discoloration due to the deterioration of the coating film surface over time was evaluated.

S: ΔE value of less than 1.3

A: ΔE value of at least 1.3 and less than 1.5

B: ΔE value of at least 1.5 and less than 2.7

C: ΔE value of at least 2.7

### Hardness of Coating Film

The pencil hardness of the coating film as the test specimen was evaluated in accordance with JIS K 5600-5-4 (2009).

### Analysis of Surface of Coating Film

The coating film surface of the test specimen was quantitatively analyzed by the energy dispersive X-ray spectroscopy by means of a scanning electron microscope under the following measuring conditions to obtain the ratio of the X-ray intensity derived of fluorine atoms to the X-ray intensity derived from silicon atoms, and the ratio was converted to a molar ratio (F_{X}/Si_{X} ratio) of fluorine atoms to silicon atoms in the coating film surface. The obtained F_{X}/Si_{X} ratio was compared with the F/Si ratio of the coating film. As a result, the F_{X}/Si_{X} ratio was higher than the F/Si ratio in all cases.

### Measuring Condition

Testing machine: JSM-5900LV manufactured by JEOL Ltd.

Accelerating voltage: 20 kV, magnification: 1,000 times

Premeasurement treatment: platinum coating at 20 mA for 45 seconds by Autofinecoater “JFC-1300”, manufactured by EOL.

TABLE 1

| Examples | | | 1 | 2 | 3 | 4 | 5 | 6 |
|---|---|---|---|---|---|---|---|---|
| No. of aqueous coating material and test specimen | | | 1 | 2 | 3 | 4 | 5 | 6 |
| Components | Aqueous dispersion of fluorinated polymer 1 | | 60 | 60 | 60 | 60 | 60 | |
| contained in | Aqueous dispersion of fluorinated polymer 2 | | | | | | | 60 |
| aqueous | Silane compound 1 | | 1 | | | | | 1 |
| coating | Silane compound 2 | | | 1 | | | | |
| material | Silane compound 3 | | | | 1 | | | |
| | Silane compound 4 | | | | | 1 | | |
| | Pigment dispersion | | 22 | 22 | 22 | 22 | 22 | 22 |
| | Film-forming assistant | | 5 | 5 | 5 | 5 | 5 | 5 |
| | Levelling agent | | 0.5 | 0.5 | 0.5 | 0.5 | 0.5 | 0.5 |
| | Thickener | | 0.5 | 0.5 | 0.5 | 0.5 | 0.5 | 0.5 |
| | Deionized water | | 11 | 11 | 11 | 11 | 12 | 11 |
| F/Si of aqueous coating material and coating film | | | 20 | 72 | 94 | 70 | 0 | 25 |
| Evaluation | Storage stability of aqueous coating material | | B | B | B | B | C | A |
| | Content of silicon atoms (mass %) | | 0.88 | 0.24 | 0.19 | 0.25 | 0 | 0.88 |
| | Hardness of coating film | | B | B | B | B | 2B | B |
| | Weather resistance of coating film | Gloss retention | A | A | B | A | C | S |
| | | ΔE value | A | B | A | A | C | S |

What is claimed is:

1. An aqueous coating material comprising particles of a fluorinated polymer having units based on a fluoroolefin and units having a hydrophilic group;
at least one hydrolysable silane selected from the group consisting of hydrolysable silanes represented by the following formulae 1 to 3 and a hydrolysable silane represented by the following formula 4, or a condensate of at least one hydrolysable silane selected from the group consisting of hydrolysable silanes represented by the following formulae 1 to 3 and a hydrolysable silane represented by the following formula 4; and
water:
NH₂—Q¹—Z¹ (Formula 1)
NH₂—X²—NH—Q²—Z² (Formula 2)
NH(—Q³—Z³)₂ (Formula 3)
R⁴—Q⁴—Z⁴ (Formula 4)
wherein Q¹, Q², Q³ and Q⁴ which are independent of one another, is a C₃₋₁₈ alkylene group or a C₃₋₁₈ alkylene group having an etheric oxygen atom, X² is a C₁₋₁₈ alkylene group, Z¹, Z², Z³ and Z⁴ which are independent of one another, is a hydrolysable silyl group, and R⁴ is a hydrogen atom, a vinyl group, an epoxy group, a methacryloyloxy group, an acryloyloxy group, a ureide group, a mercapto group or an isocyanate group.

2. The aqueous coating material according to claim 1, wherein R⁴ is a hydrogen atom or a methacryloyloxy group.

3. The aqueous coating material according to claim 1, wherein the molar ratio of fluorine atoms to silicon atoms in the aqueous coating material is from 1 to 300.

4. The aqueous coating material according to claim 1, wherein the hydrophilic group is a hydroxy group, a carboxy group or an amino group.

5. The aqueous coating material according to claim 1, which contains at least one hydrolysable silane selected from the group consisting of hydrolysable silanes represented by the formulae 1 to 3 and the hydrolysable silane represented by the formula 4, or the condensate of the hydrolysable silanes in an amount of from 0.1 to 10 mass % to the total mass of the fluorinated polymer.

6. The aqueous coating material according to claim 1, wherein R⁴ is a hydrogen atom, and Q⁴ is a C₄₋₁₀ alkylene group.

7. The aqueous coating material according to claim 1, which further contains an inorganic pigment.

8. The aqueous coating material according to claim 7, wherein the mass ratio of at least one hydrolysable silane selected from the group consisting of hydrolysable silanes represented by the formulae 1 to 3 and the hydrolysable silane represented by the formula 4, or the condensate of at least one hydrolysable silane selected from the group consisting of hydrolysable silanes represented by the formulae 1 to 3 and the hydrolysable silane represented by the formula 4 to the total mass of the inorganic pigment is from 0.01 to 0.10.

9. The aqueous coating material according to claim 7, wherein the inorganic pigment is a titanium oxide pigment.

10. The aqueous coating material according to claim 7, wherein the inorganic pigment is a titanium oxide pigment having a titanium oxide content of from 80 to 95 mass %.

11. The aqueous coating material according to claim 1, which is used for coating a ceramic building material.

12. The aqueous coating material according to claim 1, which is used as a heavy duty coating material.

13. A method for producing a substrate with a coating film, which comprises applying the aqueous coating material as defined in claim 1 on a surface of a substrate to form a coating layer and drying the coating layer to form a coating film.

14. A substrate with a coating film, which comprises a substrate and a coating film formed of the aqueous coating material as defined in claim 1 on the substrate, wherein the content of silicon atoms in the coating film to the total mass of the coating film is from 0.01 to 10 mass %, and the molar ratio of fluorine atoms to silicon atoms in the coating film is from 1 to 300.

15. The substrate with a coating film according to claim 14, wherein the pencil hardness is from 4B to H, which is measured in accordance with JIS K 5600-5-4 (2009).
